(19) United States
(12) Patent Application Publication
(10) Pub. No.: US 2026/0282096 A1
(43) Pub. Date: Sep. 17, 2026

(54) MANAGING SLICE INITIATION FOR ON-DEMAND SLICE NETWORK SERVICE

(71) Applicant: T-Mobile USA, Inc., Bellevue, WA (US)

(72) Inventor: Jasinder Pal Singh, Olathe, KS (US)

(21) Appl. No.: 19/078,002

(22) Filed: Mar. 12, 2025

(51) Int. Cl. H04W 74/0833; H04W 4/24; H04W 76/10

(52) U.S. Cl. CPC H04W 74/0833; H04W 4/24; H04W 76/10

(57) ABSTRACT

An electronic device can receive a payment via a software application to initiate an on-demand slice connection within a wireless network. Upon receiving the payment, the device can send a request to a base station through a physical random access channel (PRACH). The request can identify a specific PRACH preamble from a pre-defined sub-set allocated for on-demand slice connections. Upon receiving the request, the base station can be configured to assign PRACH resources for communication. The assigning can include mapping the PRACH resources to a set of inner physical resource blocks (PRBs) located at a center region of a PRACH frequency band. The device and the base station can exchange messages using these inner PRBs to establish the on-demand slice connection.

### BACKGROUND

A network slice service is a virtualized network architecture that allows multiple isolated and independent end-to-end networks to be created on a shared physical infrastructure. Each network slice can be tailored to meet specific requirements, such as latency, bandwidth, and security, to enable customized services for different applications and user devices. This technology is pivotal in 5G networks, providing the flexibility to support diverse use cases, from enhanced mobile broadband to ultra-reliable low-latency communications and massive machine-type communications. By leveraging network slicing, service providers can efficiently allocate resources and optimize network performance to meet varying demands.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a block diagram that illustrates an example network slicing system in a 5G network.

FIG. 4 is a block diagram that illustrates an environment for providing and managing network slice connections in accordance with some embodiments.

FIG. 5A is a flow chart that illustrates a process for managing network slice initiation for an on-demand network slice service in accordance with some embodiments.

FIG. 5B is a flow chart that illustrates a process for managing network slice initiation for an on-demand network slice service in accordance with some embodiments.

FIG. 6 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present technology is related to providing on-demand network slice services. An on-demand network slice service includes providing customers immediate access to network slice connection upon a customer requesting it. An on-demand network slice service can be facilitated through a software application on a user device and be initiated by a user's request (e.g., including a payment). As an example, a user can request to initiate an on-demand slice connection by making a payment through a software application on their user device. In response to receiving the payment, a network base station can establish such a slice connection for the user device. The process of initiating a slice connection is done through messages between the network base station and the user device via a physical random access channel (PRACH).

Conventionally, establishing a slice network connection can fail due to noise interference on the PRACH that interrupts messaging between a user device and a network base station. Noise interference on the PRACH can be caused, for example, by overlapping signals from multiple user devices and/or nearby base stations. Noise can reduce signal integrity and data transmission within the PRACH that leads to loss of messages required for establishing a slice network connection. Low noise PRACH (e.g., via inner physical resource blocks, referred to herein as PRBs, located in the center of a frequency band) communication is critical for establishment of slice connections reliably. However, conventional systems do not provide any means of assuring that the communication required for establishing an on-demand slice connection is directed to low noise PRACH. This can lead to unreliable initiation of on-demand slice connections and reduce customer experience.

The present technology provides for a method to assure that an on-demand slice connection is established by directing the communication for establishing such a connection through a low noise PRACH. The method includes assigning a portion of available PRACH preambles that facilitate the allocation of PRACH resources during network slice establishment to on-demand network slices. When a user device transmits to the base station a request for a slice connection that includes one of the assigned PRACH preambles, the base station directs the messaging required to establish the slice connection through the low noise PRACH. This ensures that noise does not interfere with the communication and results in a reliable manner of establishing on-demand slice network connections.

In some implementations, the present technology can be configured to provide such assured establishment of slice connection to services other than on-demand service (e.g., no payment is required to initiate the implementation of the technology). For example, the present technology can be applied for particular subscriptions that include guaranteed establishment of slice connections. As another example, the present technology can be applied for particular applications that have high importance. Such particular applications can include network slices for medical and health care services, emergency services, and/or military or security services. In some implementations, the present technology can be configured to provide network slices for certain geographical areas.

In one example, an electronic device in communication with a wireless network receives a payment to initiate an on-demand slice connection within the wireless network. The payment can be received via a software application operating on the device. Responsive to receiving the payment, the device can transmit a request to initiate the on-demand slice connection to a base station associated with the wireless network through a physical random access channel (PRACH). The request can identify a particular PRACH preamble selected from a pre-defined sub-set of PRACH preambles. The pre-defined sub-set of PRACH preambles can be allocated for establishing on-demand slice connections. Upon receiving the request, the base station can be configured to assign PRACH resources for communication between the device and the base station to exchange messaging required for initiating the on-demand slice connection. Assigning the PRACH resources can include mapping the communication between the device and the base station to a set of inner PRBs. The set of inner PRBs can be located in a center region of a frequency band. The device can exchange messages required for initiating the on-demand slice connection with the base station using the set of inner PRBs to establish the on-demand slice connection between the device and the base station.

In another example, a base station for managing on-demand slice connections in a wireless network receives a request to initiate the on-demand slice connection to an electronic device associated with the wireless network through a PRACH. The request can identify a particular PRACH preamble selected from a pre-defined sub-set of PRACH preambles. The pre-defined sub-set of PRACH preambles can be allocated for establishing on-demand slice connections. Responsive to receiving the request, the base station can assign PRACH resources for communication between the device and the base station to exchange messaging required for initiating the on-demand slice connection. Assigning the PRACH resources can include mapping the communication between the device and the base station to a set of inner PRBs. The set of inner PRBs can be located in a center region of a frequency band. The base station can exchange messages required for initiating the on-demand slice connection with the electronic device using the set of inner PRBs to establish the on-demand slice connection between the device and the base station.

In yet another example, a method for managing slice connections in a wireless network includes transmitting a request to initiate the slice connection to a base station associated with the wireless network by an electronic device. The request can be sent through a PRACH. The request can identify a particular PRACH preamble selected from a pre-defined sub-set of PRACH preambles. The pre-defined sub-set of PRACH preambles can be allocated for establishing certain slice connections. The base station can be configured to assign PRACH resources for communication between the device and the base station to exchange messaging required for initiating the slice connection, upon receiving the request. Assigning the PRACH resources can include mapping the communication between the device and the base station to a set of inner PRBs. The set of inner PRBs can be located in a center region of a frequency band. The method can include exchanging messages required for initiating the slice connection with the base station using the set of inner PRBs to establish the slice connection between the device and the base station.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

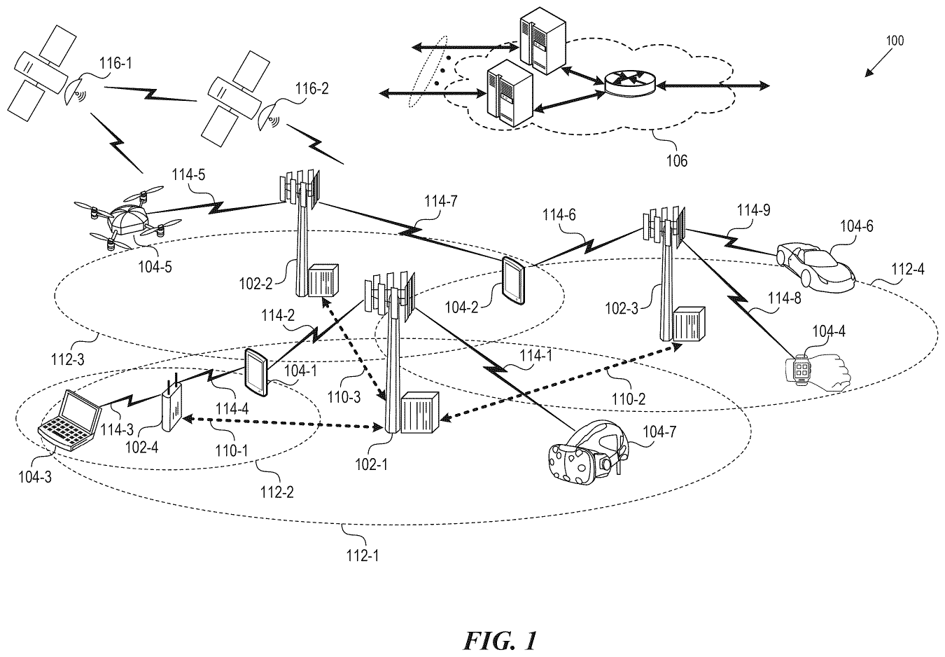

FIG. 1 is a block diagram that illustrates a wireless telecommunication network 100 (“network 100”) in which aspects of the disclosed technology are incorporated.

The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

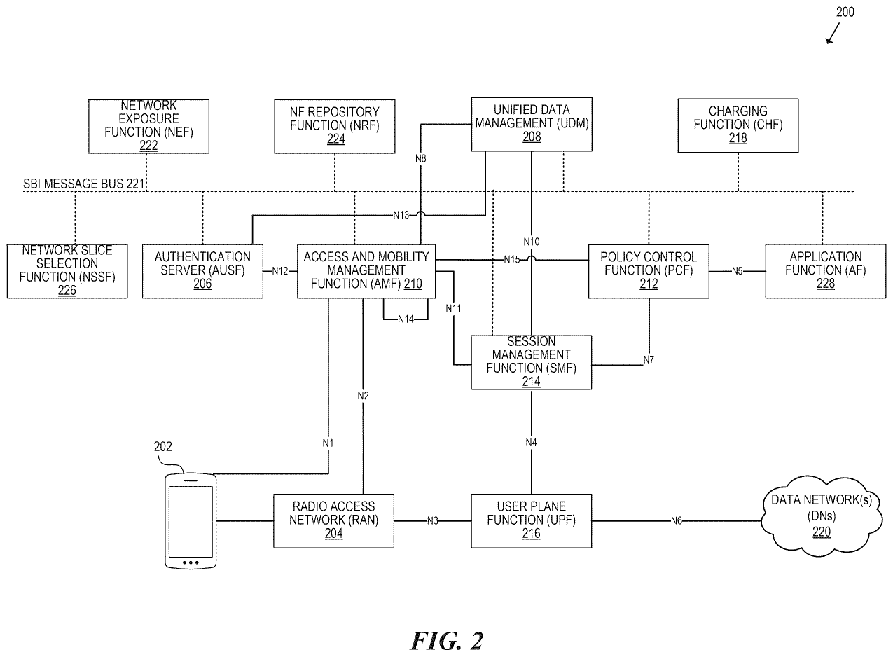

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Management of Network Slicing

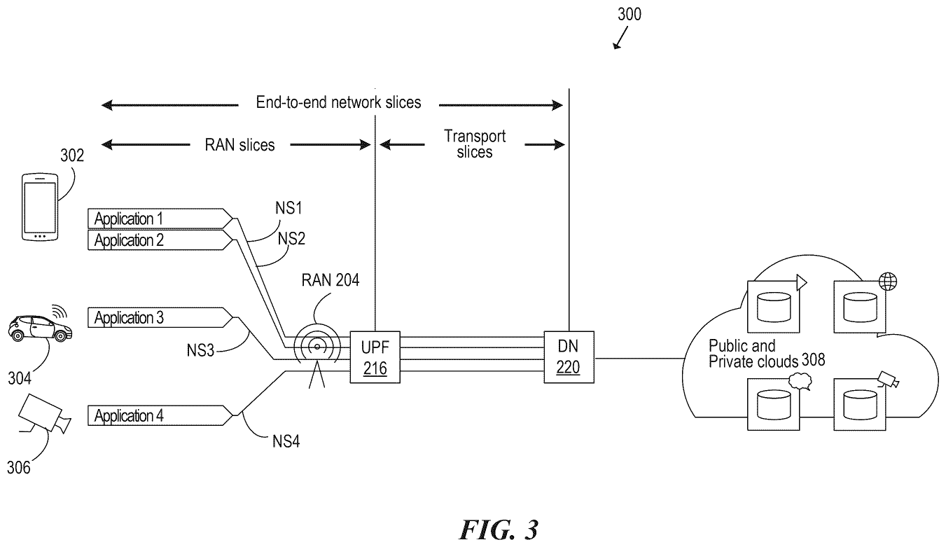

FIG. 3 is a block diagram that illustrates an example network slicing system 300 in a 5G network. The network slicing system 300 enables multiplexing of virtualized and independent logical networks (i.e., network slices NS1 through NS4) on the same physical network infrastructure. In 5G wireless networks, network slicing assumes a central role designed to efficiently embrace multiple services with very different service-level requirements (e.g., data transfer speed, reliability, bandwidth). The end-to-end network slices can be defined between wireless devices (e.g., wireless devices 302, 304, and 306) and DN 220. For example, each network slice is an isolated end-to-end network tailored to fulfill diverse requirements requested by a particular application (e.g., wireless applications 1 through 4 associated with the wireless devices 302, 304, and 306). The network slicing system 300 can be in communication with public and private clouds 308. For example, the clouds 308 can include cloud servers associated with the different wireless applications 1 through 4.

An infrastructure associated with the network slicing system includes hardware and software resources, such as user equipment and/or compute-, storage-and networking-hardware equipment, as well as the services and software programs stored therein. The infrastructure can be used to implement physical network nodes and/or to define a distributed cloud environment, such as Physical Network Functions (PNFs) and/or the Network Functions Virtualization Infrastructure (NFVI). The infrastructure provides the support and management functionality that allows for the deployment and operation of individual network slices. The infrastructure can include a collection of PNFs. For example, it provides the user control and application plane functionality across the different network segments, including the RAN slices between wireless devices (e.g., wireless devices 302, 304, and 306) and the UPF 216 and transport slices between the UPF 216 and DN 220.

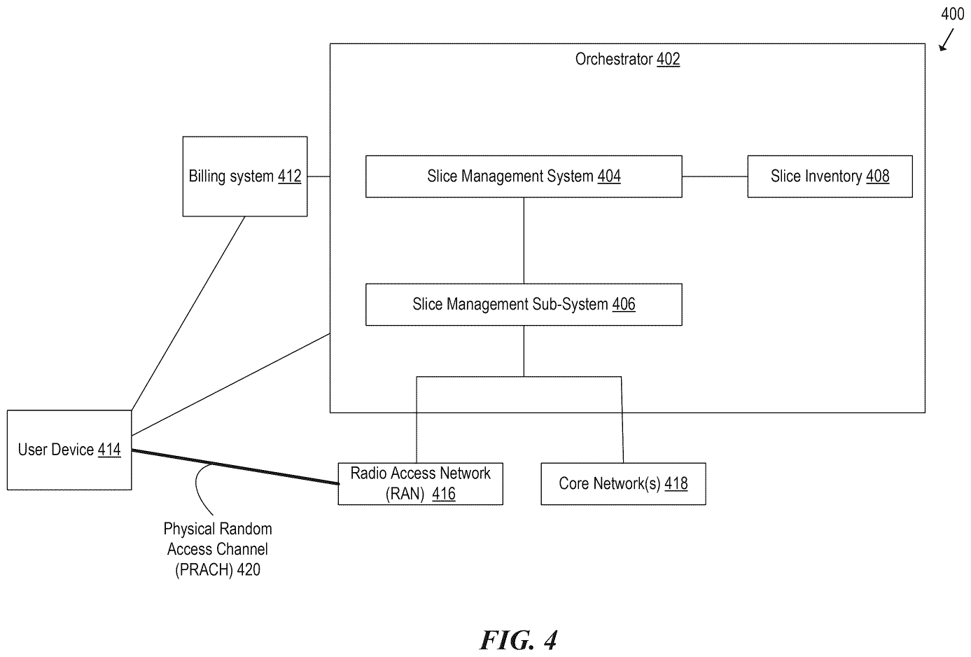

FIG. 4 is a block diagram that illustrates an environment 400 for providing and managing network slice connections in accordance with some embodiments. The environment 400 can include an orchestrator 402, a billing system 412, one or more radio access networks (e.g., the RAN 416), and core network functions 418 (e.g., corresponding to the core network functions 106 described with respect to FIG. 2). The environment 400 can be associated with the network 100 described with respect to FIG. 1. The environment 400 is in communication with multiple user devices (e.g., a user device 414) associated with a wireless network (e.g., the network 100 in FIG. 1). The RAN 416 and the core network functions 418 are associated with base stations (e.g., the base stations 102 in FIG. 1). The environment 400 is configured to provide network slice connections (e.g., the network slices NS1 through NS4 in FIG. 3) to the user devices and manage the slice connection operations, including establishing network slice connections between the user devices and the RAN 416.

The orchestrator 402 is configured to manage and allocate slice network resources dynamically to create multiple virtual networks on a shared physical infrastructure. For example, the orchestrator 402 facilitates the establishment of network slices such that each slice meets performance and service requirements. The orchestrator 402 can include a slice management system 404, a slice inventory 408, and a slice management sub-system 406. The slice management system 404 can include a communication service management function (CSMF) and a network slice management function (NSMF). The CSMF can be configured to act as an intermediary between a customer-facing service layer (e.g., the user device 414 and/or the billing system 412) and a network-facing management layer (e.g., the slice management sub-system 406). The NSMF can be configured to establish, monitor, and/or terminate network slice connections. For example, the NSMF can facilitate proper configuration of network slices and meeting requirements and service level agreements (SLAs) defined by the CSMF. The slice management system 404 can be in communication with the slice inventory 408. The slice inventory 408 can include a repository that facilitates tracking of the network slices, including their configurations, resources, and status, within a network slicing environment.

The slice management system 404 communicates with the slice-management sub-system 406. The slice-management sub-system 406 can include one or more network slice subnet management functions (NSSMFs). Each NSSMF can be associated with a particular network slice subnet (e.g., an R-NSSMF for the RAN 416 and a C-NSSMF for the core network functions 418). An NSSMF can manage resource allocation, slice configuration, and monitoring within its particular network slice subnet to ensure the proper functioning and performance of a network slice within the subnet.

The billing system 412 is in communication with the user devices, such as the user device 414. The billing system 412 can be configured to process payments, manage the usage data, calculate charges, and generate invoices for customers based on their service plans (subscriptions) and/or consumption. In some implementations, the communication is through a software application associated with the network 100 and operating on the user devices. For example, the software application is provided by a service provider associated with the network 100. A user can manage their network connections, including slice network connections, through the software application. A user can, for example, request an on-demand slice connection through the software application on their user device 414. In some implementations, the request can be associated with a payment. In such implementations, a user can make a payment (e.g., an online payment with a credit card) on their user device 414 (or on a different device). The payment can be received by the billing system 412, which then transmits an indication to the orchestrator 402 (e.g., the slice management system 404) that indicates that the user device 414 is requesting the on-demand network connection.

To establish an on-demand slice connection, the user device 414 can send a request (e.g., using the software application associated with the network 100) to initiate slice connection establishment to the RAN 416 via a PRACH 420. The request can include a PRACH preamble, which is a short, unique signal transmitted by the user device 414 to the RAN 416 to initiate the random access procedure and establish initial communication. The PRACH preamble can include a preamble sequence that operates as an identifier for the attempt to initiate a slice connection and timing information (e.g., a timestamp). A PRACH preamble can be selected from a set of predefined PRACH preambles. For example, the set of PRACH preambles for the LTE and 5G NR networks includes 64 PRACH preambles. In some implementations, the communication between the user device 414 and the billing system, the orchestrator 402 and/or the base station for establishing on-demand slice connection can be facilitated by the software application on the user device 414.

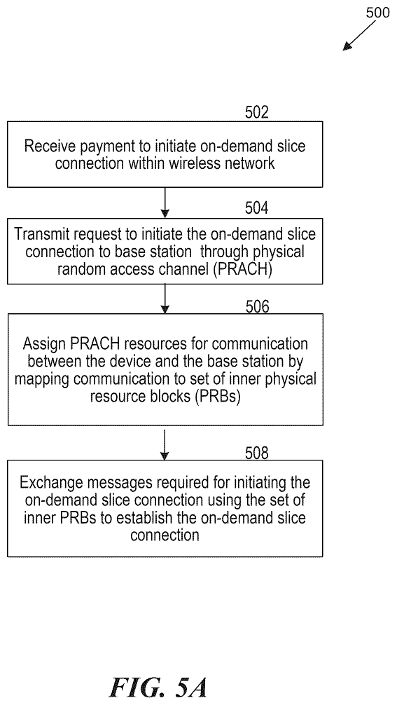

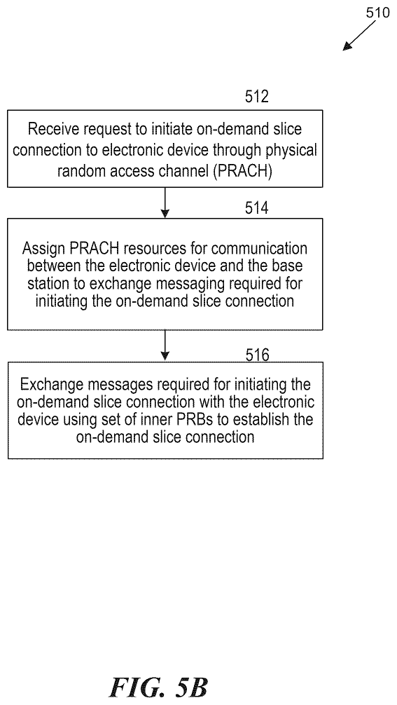

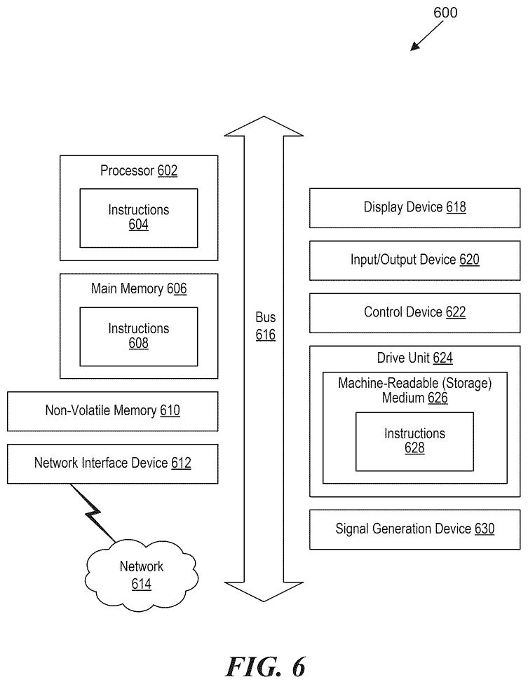

FIG. 5A is a flow chart that illustrates process for managing network slice initiation for an on-demand network slice service in accordance with some embodiments. The process 500 can be performed by an electronic device associated with a wireless network (e.g., the wireless network 100 in FIG. 1). For example, the process 500 can be performed by the user device 414 in communication with the environment 400 described with respect to FIG. 4. The device can include at least one hardware processor and at least one non-transitory memory storing instructions (e.g., a computer system 600 described with respect to FIG. 6). When the instructions are executed by the at least one hardware processor, the device performs the process 500.

The process 500 is directed to ensuring the establishment of on-demand (e.g., payment-based on-demand) slice connections (or other specific slice connections) by directing the communication for such connections through a low-noise communication channels, such as inner PRBs located in the center region of a frequency band. The communication channels include uplink (UL) messaging from a user device to a base station) and downlink (DL) messaging from a base station to a user device. This process can include assigning a portion of available PRACH preambles to facilitate the allocation of PRACH resources during network slice establishment for on-demand slices. When a user device transmits a request for a slice connection to the base station, including one of the assigned PRACH preambles, the base station can direct the necessary messaging through the low-noise PRACH (e.g., PRACH including UL messaging), ensuring reliable communication free from noise interference. Additionally, this technology can be configured to assure slice connection establishment for services beyond on-demand services, such as particular subscriptions with guaranteed slice connections or high-importance applications such as medical, emergency, military, or security services. It can also be applied to provide network slices for specific geographical areas.

At 502, the device can receive a payment to initiate an on-demand slice connection within the wireless network. The user device 414 can include any type of electronic device capable of connecting to a network, such as devices 302, 304, and 306 in FIG. 3 and devices 104 in FIG. 1. The device can include a software application that enables a user to request, initiate, and establish a slice network connection. For example, the payment can be received via the software application operating on the device. The payment can include authorization via the software application to make a payment which is configured to be received by the billing system 412. For example, in FIG. 4, the communication between the user device 414 and the billing system, the orchestrator 402 and/or the base station can be facilitated by the software application on the user device 414.

At 504, responsive to receiving the payment, the device can transmit a request to initiate the on-demand slice connection to a base station (e.g., the RAN 416 in FIG. 1) associated with the wireless network through a PRACH. In some implementations, the base station is a radio transceiver, a gNodeB (gNB), a NodeB, or an eNodeB (eNB) base station (e.g., as described with respect to the base stations 102 in FIG. 1). The request can identify a particular PRACH preamble selected from a pre-defined sub-set of PRACH preambles available to establish slice network connections in the telecommunications network. The pre-defined sub-set of PRACH preambles can be allocated for establishing on-demand slice connections. In some implementations, the pre-defined sub-set of PRACH preambles includes three or more PRACH preambles (e.g., three, four, five, or ten preambles selected out of 64 or more available PRACH preambles). The PRACH preambles can be assigned by the systems of the environment 400. In some implementations, the orchestrator 402 is configured to select and assign a certain number of available PRACH preambles to the pre-defined sub-set of PRACH preambles and communicate information (e.g., identification sequences) related to the defined sub-set of PRACH preambles to the base station and to the device.

In some implementations, receiving the payment includes receiving a confirmation notification from a billing system associated with the wireless network that the payment was registered by the billing system. For example, the billing system 412 in communication with the orchestrator 402 in FIG. 4 can transmit a notification to the slice management system 404 that a payment is received from the user device 414. In some implementations, the device can receive, via the software application, a user input to initiate the on-demand slice connection. The device can then generate the request to initiate the on-demand slice connection responsive to the received user input and/or the received payment. For example, in some instances, the request for the on-demand slice connection does not require a payment. Instead, for example, an on-demand slice service can be a part of a user's subscription to the telecommunications network and be billed from the user afterward. In such instances, the request to initiate the on-demand slice connection can be initiated via an input via the software application on the user device.

In some implementations, the particular PRACH preamble of the request includes a particular identification sequence. The base station can compare the particular identification sequence of the particular PRACH preamble to the identification sequences of the pre-defined sub-set of PRACH preambles to identify whether the request is for the on-demand slice connection.

At 506, responsive to receiving the request, the device can cause the base station to assign PRACH resources for communication between the device and the base station to exchange messaging required for initiating the on-demand slice connection. Assigning the PRACH resources can include mapping the communication between the device and the base station to a set of inner PRBs. The set of inner PRBs can be mapped for both UL and DL messaging between the base station and the user device. The set of inner PRBs can be located in a center region of a frequency band. The center region can include any frequency region of the frequency band that is not located on the outermost edge of the frequency band. In some implementations, the set of inner PRBs mapped for the communication include the inner PRBs located at the center of the frequency band. In some implementations, the set of inner PRBs are configured to provide communication with reduced interference (e.g., noise) from other network communications. For example, the set of inner PRBs is located on the frequency band so that there is no overlap in communication from other user devices or nearby base stations.

At 508, the device can exchange messages, including UL and UD messages, required for initiating the on-demand slice connection with the base station using the set of inner PRBs to establish the on-demand slice connection between the device and the base station. The reduced interference provided by the set of inner PRBs can improve signal integrity and data transmission within the PRACH leading to more reliable communication of messages required for establishing the on-demand slice network connection. In some implementations, exchanging the messages required for initiating the on-demand slice connection includes messages for RRC (Radio Resource Control) setup and reconfiguration, authentication of the device, establishing security for the on-demand slice connection, and determining slice capabilities of the device.

In some implementations, the device can establish the on-demand slice connection between the device and the base station. Subsequent to establishing the on-demand slice connection, the base station can forgo assigning the PRACH resources mapped to the inner PRBs for the communication between the device and the base station.

In some implementations, the device transmits an additional request to initiate an additional slice connection to the base station through the PRACH. The additional request can identify an additional PRACH preamble that is not selected from the pre-defined sub-set of PRACH preambles. For example, the additional slice connection is not categorized as an on-demand slice connection but can be part of a user's subscription to the network services and thereby does not have any specialized status. The additional PRACH preamble is therefore selected from the PRACH preambles that are not allocated for on-demand network slices (e.g., any other of the 64 PRACH preambles than the allocated ones). In such implementations, the device can cause the base station, responsive to receiving the additional request, to assign PRACH resources for communication between the device and the base station to exchange messaging required for initiating the additional slice connection without mapping the communication to the set of inner PRBs. The PRACH communication can be there for via any PRBs of the frequency band (inner or outer of a combination thereof).

FIG. 5B is a flow chart that illustrates process 510 for managing network slice initiation for an on-demand network slice service in accordance with some embodiments. The process 510 can be performed by a base station associated with a wireless network (e.g., any of the base stations of wireless network 100 in FIG. 1). The base station can be part of the RAN 416 of FIG. 4 and the process 510 can be performed in the environment 400 described with respect to FIG. 4. The device can include at least one hardware processor and at least one non-transitory memory storing instructions (e.g., the computer system 600 described with respect to FIG. 6). When the instructions are executed by the at least one hardware processor, the device performs the process 510.

At 502, the base station can receive request to initiate the on-demand slice connection to an electronic device (e.g., the user device 414) associated with the wireless network through a PRACH (e.g., the PRACH 420 in FIG. 4). The request can be received from the electronic device. The request can identify a particular PRACH preamble selected from a pre-defined sub-set of PRACH preambles. The pre-defined sub-set of PRACH preambles can be allocated for establishing on-demand slice connections (e.g., by the slice orchestrator).

At 504, responsive to receiving the request, the base station can assign PRACH resources for communication between the device and the base station to exchange messaging required for initiating the on-demand slice connection. Assigning the PRACH resources can include mapping the communication between the device and the base station to a set of inner PRBs. The set of inner PRBs can be located in a center region of a frequency band.

At 506, the base station can exchange messages required for initiating the on-demand slice connection with the electronic device using the set of inner PRBs to establish the on-demand slice connection between the device and the base station.

In some implementations, the pre-defined sub-set of PRACH preambles can comprise three or more PRACH preambles.

In some implementations, the particular PRACH preamble includes a particular identification sequence. The base station can compare the particular identification sequence to identification sequences of the pre-defined sub-set of PRACH preambles (e.g., provided by the slice orchestrator) to identify that the request is for the on-demand slice connection.

In some implementations, the base station can receive an additional request to initiate an additional slice connection to the electronic device through the PRACH. The additional request can identify an additional PRACH preamble which is not selected from the pre-defined sub-set of PRACH preambles. Responsive to receiving the additional request, the base station can assign PRACH resources for communication between the electronic device and the base station to exchange messaging required for initiating the additional slice connection without mapping the communication to the set of inner PRBs.

In some implementations, exchanging the messages required for initiating the on-demand slice connection can comprise messages for RRC (Radio Resource Control) setup and reconfiguration, authentication of the electronic device, establishing security for the on-demand slice connection, and determining slice capabilities of the electronic device.

### Computer System

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, a video display device 618, an input/output device 620, a control device 622 (e.g., keyboard and pointing device), a drive unit 624 that includes a machine-readable (storage) medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computing system 600 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 600. In some implementations, the computer system 600 can be an embedded computer system, a system-on-chip (SOC), a single-board computer system (SBC), or a distributed system such as a mesh of computer systems, or it can include one or more cloud components in one or more networks. Where appropriate, one or more computer systems 600 can perform operations in real time, in near real time, or in batch mode.

The network interface device 612 enables the computing system 600 to mediate data in a network 614 with an entity that is external to the computing system 600 through any communication protocol supported by the computing system 600 and the external entity. Examples of the network interface device 612 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable medium 626 can include any medium that is capable of storing, encoding, or carrying a set of instructions for execution by the computing system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computing system 600 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. An electronic device in communication with a wireless network, the device comprising:
at least one hardware processor; and
at least one non-transitory memory storing instructions, which, when executed by the at least one hardware processor, cause the device to:
receive, via a software application operating on the device, a payment to initiate an on-demand slice connection facilitated by the wireless network;
responsive to receiving the payment, transmit a request to initiate the on-demand slice connection to a base station associated with the wireless network through a physical random access channel (PRACH),
wherein the request identifies a particular PRACH preamble selected from a pre-defined sub-set of PRACH preambles,
wherein the pre-defined sub-set of PRACH preambles is allocated for establishing on-demand slice connections,
wherein, upon receiving the request, the base station is configured to assign PRACH resources for communication between the device and the base station to exchange messaging required for initiating the on-demand slice connection,
wherein assigning the PRACH resources comprises mapping the communication between the device and the base station to a set of inner physical resource blocks (PRBs), and
wherein the set of inner PRBs are located in a center region of a frequency band; and
exchange messages required for initiating the on-demand slice connection with the base station using the set of inner PRBs to establish the on-demand slice connection between the device and the base station.

2. The device of claim 1, wherein the device is further caused to:
receive, via the software application, a user input to initiate the on-demand slice connection; and
generate the request to initiate the on-demand slice connection responsive to the received user input and the received payment.

3. The device of claim 1,
wherein the particular PRACH preamble of the request includes a particular identification sequence, and
wherein the base station is caused to compare the particular identification sequence to identification sequences of the pre-defined sub-set of PRACH preambles to identify that the request is for the on-demand slice connection.

4. The device of claim 1, wherein the device is further caused to:
transmit an additional request to initiate an additional slice connection to the base station through the PRACH,
wherein the additional request identifies an additional PRACH preamble which is not selected from the pre-defined sub-set of PRACH preambles; and
cause the base station, responsive to receiving the additional request, to assign PRACH resources for communication between the device and the base station to exchange messaging required for initiating the additional slice connection without mapping the communication to the set of inner PRBs.

5. The device of claim 1,
wherein the pre-defined sub-set of PRACH preambles comprises three or more PRACH preambles.

6. The device of claim 1,
wherein exchanging the messages required for initiating the on-demand slice connection comprises messages for RRC (Radio Resource Control) setup and reconfiguration, authentication of the device, establishing security for the on-demand slice connection, and determining slice capabilities of the device.

7. The device of claim 1, wherein the device is further caused to:
establish the on-demand slice connection between the device and the base station; and
subsequent to establishing the on-demand slice connection, forgo assigning the PRACH resources mapped to the inner PRBs for the communication between the device and the base station.

8. The device of claim 1,
wherein receiving the payment comprises receiving a confirmation notification from a billing system associated with the wireless network that the payment was registered by the billing system.

9. The device of claim 1,
wherein the set of inner PRBs are configured to provide a communication with a reduced interference from other network communications.

10. The device of claim 1,
wherein the base station is a radio transceiver, a gNodeB (gNB), a NodeB, or an eNodeB (eNB) base station.

11. A base station for managing on-demand slice connections in a wireless
network, the base station comprising:
at least one hardware processor; and
at least one non-transitory memory storing instructions, which, when executed by the at least one hardware processor, cause the base station to:
receive a request to initiate an on-demand slice connection to an electronic device associated with the wireless network through a physical random access channel (PRACH),
wherein the request identifies a particular PRACH preamble selected from a pre-defined sub-set of PRACH preambles, and
wherein the pre-defined sub-set of PRACH preambles is allocated for establishing on-demand slice connections;
responsive to receiving the request, assign PRACH resources for communication between the electronic device and the base station to exchange messaging required for initiating the on-demand slice connection,
wherein assigning the PRACH resources comprises mapping the communication between the electronic device and the base station to a set of inner physical resource blocks (PRBs), and
wherein the set of inner PRBs are located in a center region of a frequency band; and
exchange messages required for initiating the on-demand slice connection with the electronic device using the set of inner PRBs to establish the on-demand slice connection between the electronic device and the base station.

12. The base station of claim 11,
wherein the particular PRACH preamble of the request includes a particular identification sequence, and
wherein the base station is caused to compare the particular identification sequence to identification sequences of the pre-defined sub-set of PRACH preambles to identify that the request is for the on-demand slice connection.

13. The base station of claim 11, wherein the base station is further caused to:
receive an additional request to initiate an additional slice connection to the electronic device through the PRACH,
wherein the additional request identifies an additional PRACH preamble which is not selected from the pre-defined sub-set of PRACH preambles; and
responsive to receiving the additional request, assign PRACH resources for communication between the electronic device and the base station to exchange messaging required for initiating the additional slice connection without mapping the communication to the set of inner PRBs.

14. The base station of claim 11,
wherein the pre-defined sub-set of PRACH preambles comprises three or more PRACH preambles.

15. The base station of claim 11,
wherein exchanging the messages required for initiating the on-demand slice connection comprises messages for RRC (Radio Resource Control) setup and reconfiguration, authentication of the electronic device, establishing security for the on-demand slice connection, and determining slice capabilities of the electronic device.

16. A method for managing slice connections in a wireless network, the method comprising:
transmitting, by an electronic device, a request to initiate the slice connection to a base station associated with the wireless network through a physical random access channel (PRACH),
wherein the request identifies a particular PRACH preamble selected from a pre-defined sub-set of PRACH preambles,
wherein the pre-defined sub-set of PRACH preambles is allocated for establishing certain slice connections,
wherein, upon receiving the request, the base station is configured to assign PRACH resources for communication between the electronic device and the base station to exchange messaging required for initiating slice connection,
wherein assigning the PRACH resources comprises mapping the communication between the electronic device and the base station to a set of inner physical resource blocks (PRBs), and
wherein the set of inner PRBs are located in a center region of a frequency band; and
exchanging messages required for initiating the slice connection with the base station using the set of inner PRBs to establish the slice connection between the electronic device and the base station.

17. The method of claim 16, further comprising:
receiving, by the electronic device, a user input to initiate the slice connection; and
generating the request to initiate the on-demand slice connection responsive to the received user input.

18. The method of claim 16,
wherein the particular PRACH preamble of the request includes a particular identification sequence, and
wherein the base station is caused to compare the particular identification sequence to identification sequences of the pre-defined sub-set of PRACH preambles to
identify that the request is for the on-demand slice connection.

19. The method of claim 16, further comprising:
transmitting, by the electronic device, an additional request to initiate an additional slice connection to the base station through the PRACH, wherein the additional request identifies an additional PRACH preamble which is not selected from the pre-defined sub-set of PRACH preambles; and
causing the base station, responsive to receiving the additional request, to assign PRACH resources for communication between the electronic device and the base station to exchange messaging required for initiating the additional slice connection without mapping the communication to the set of inner PRBs.

20. The method of claim 16,
wherein the pre-defined sub-set of PRACH preambles comprises three or more PRACH preambles.
